(19) United States
(12) Patent Application Publication
(10) Pub. No.: US 2024/0127137 A1
(43) Pub. Date: Apr. 18, 2024

(54) SYSTEMS AND METHODS FOR FLEET OBSOLESCENCE MANAGEMENT

(71) Applicant: Ford Global Technologies, LLC, Dearborn, MI (US)

(72) Inventors: Stuart C. Salter, White Lake, MI (US); Sanjay Dayal, Saratoga, CA (US); Ryan O'Gorman, Beverly Hills, MI (US); Pietro Buttolo, Dearborn Heights, MI (US)

(73) Assignee: Ford Global Technologies, LLC, Dearborn, MI (US)

(21) Appl. No.: 18/046,229

(22) Filed: Oct. 13, 2022

(51) Int. Cl. G06Q 10/06; G07C 5/00

(52) U.S. Cl. CPC G06Q 10/06311; G07C 5/008

(57) ABSTRACT

Systems and methods for fleet management for a fleet of vehicles include collecting data associated with the fleet of vehicles including data associated with a plurality of vehicle operations affecting degradation of each vehicle in the fleet of vehicles, determining a composite score associated with the fleet of vehicles based on the collected data, the composite score associated with both an average score for the fleet and a standard deviation score associated with each vehicle in the fleet of vehicles, wherein a higher composite score relates to a slower degradation of the fleet of vehicles, and altering assignment of the plurality of vehicle operations assigned to each vehicle in the fleet of vehicles based on the composite score data to enable a higher composite score by equalizing an average degradation of the fleet of vehicles.

### FIELD

This disclosure generally relates to vehicles and more particularly relates to systems and methods for vehicle fleet management.

### BACKGROUND

Fleet management refers to maximizing the overall life expectancy of a fleet of vehicles. A fleet of vehicles may include any number of vehicles of a similar age and useful life such that management of the vehicles enables a same overall life expectancy of the fleet. The benefits of managing a fleet include the ability to plan for replacements and maintain reliability of the fleet of vehicles. When a single vehicle becomes obsolete much earlier than other vehicles in the same fleet, the manager of a fleet as a whole may incur costs. For example, a leased fleet of vehicles with differing vehicles such that the obsolescence of the fleet is varied and difficult to predict may be more expensive to maintain than a more predictable fleet of vehicles.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system that includes a fleet of vehicles in accordance with an embodiment of the disclosure.

FIG. 2 illustrates some example functional blocks that may be included in a computer server in accordance with an embodiment of the disclosure.

FIG. 3 illustrates a decision flow diagram illustrating an exemplary flow diagram for implementing fleet management in accordance with an embodiment of the disclosure.

FIG. 4 illustrates an exemplary flow diagram of a method in accordance with an embodiment of the disclosure.

FIG. 5 illustrates an electric vehicle in accordance with an embodiment of the disclosure.

### DETAILED DESCRIPTION

### Overview

In terms of a general overview, this disclosure is directed to systems and methods for fleet management for a fleet of vehicles. One or more embodiments of a method include collecting data associated with the fleet of vehicles including data associated with a plurality of vehicle operations affecting degradation of each vehicle in the fleet of vehicles, determining a composite score associated with the fleet of vehicles based on the collected data, the composite score associated with both an average score for the fleet and a standard deviation score associated with each vehicle in the fleet of vehicles, wherein a higher composite score relates to a slower degradation of the fleet of vehicles, and altering assignment of the plurality of vehicle operations assigned to each vehicle in the fleet of vehicles based on the composite score data to enable a higher composite score by equalizing an average degradation of the fleet of vehicles.

In one or more embodiments, the collecting data associated with the fleet of vehicles including data associated with the plurality of vehicle operations affecting degradation of each vehicle in the fleet of vehicles includes collecting data on the plurality of vehicle operations affecting degradation including a duty cycle for each vehicle, a battery degradation measurement associated with each vehicle, a storage method associated with each vehicle, route conditions associated with each vehicle, and a maintenance schedule for tires, fluids and brakes for each vehicle. Route conditions associated with each vehicle may include a climate, an altitude, road conditions, a time of driving, a manner of driving, and idle durations.

In one or more embodiments, determining the composite score associated with the fleet of vehicles based on the collected data, includes assigning the vehicle operations to the fleet of vehicles, assigning a vehicle score for each of the vehicles in the fleet of vehicles, each vehicle starting with a same new vehicle score based on expected longevity, determining a revised vehicle score based on expected wear for each vehicle operation, swapping vehicle operations assigned to random pairs of vehicles in the fleet of vehicles to evaluate an impact on the composite score of the fleet of vehicles, if the swapping of vehicle operations to the random pairs of vehicles increases the composite score of the fleet of vehicles, maintaining the swapping of vehicle operations, if the swapping of vehicle operations decreases the composite score of the fleet of vehicles, reverting the swapping of vehicle operations, and repeating the swapping of vehicle operations until a convergence to a lowest possible standard deviation affecting the composite score of the fleet of vehicles.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternative implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

It should also be understood that the word “example” as used herein is intended to be non-exclusionary and non-limiting in nature. Furthermore, certain words and phrases that are used herein should be interpreted as referring to various objects and actions that are generally understood in various forms and equivalencies by persons of ordinary skill in the art. For example, the word “application” or the phrase “software application” as used herein with respect to a mobile device such as a smartphone, refers to code (software code, typically) that is installed in the mobile device. The code may be launched and operated via a human machine interface (HMI) such as a touchscreen. The word “action” may be used interchangeably with words such as “operation” and “maneuver” in the disclosure. The word “maneuvering” may be used interchangeably with the word “controlling” in some instances. The word “vehicle” as used in this disclosure can pertain to any one of various types of vehicles such as cars, vans, sports utility vehicles, trucks, electric vehicles, gasoline vehicles, hybrid vehicles, and autonomous vehicles. Phrases such as “automated vehicle,” “autonomous vehicle,” and “partially-autonomous vehicle” as used in this disclosure generally refer to a vehicle that can perform at least some operations without a driver being seated in the vehicle.

The Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations. Level 3 (L3) vehicles provide conditional driving automation but are smarter in terms of having an ability to sense a driving environment and certain driving situations. Level 4 (L4) vehicles can operate in a self-driving mode and include features where the vehicle computer can take control. The level of human intervention is very low. Level 5 (L5) vehicles are fully autonomous vehicles that do not involve human participation.

Embodiments herein include systems and methods for fleet obsolescence management. In accordance with one or more embodiments, the systems and methods maximize the overall life expectancy of a fleet. More particularly, embodiments enable a fleet manager via computer implemented systems, to schedule vehicle tasks, such as routing, fueling and/or charging, and maintenance.

In one or more embodiments, a “vehicle life expectancy score” (VLES) applies to enable a fleet manager to determine which vehicle in a fleet should be assigned different activities, operations, tasks and anything that might affect the longevity of the vehicle. For example, the VLES might be based on known parameters, such as aggregate vehicle wear. The VLES may also be based on other factors, such as lease requirements as stated in a contract upon return of the vehicle, such as maximum mileage and minimum percentage battery life expected. In one or more embodiments, the VLES score is impacted by all actions performed on the vehicle. For example, for electric vehicles the speed and type of charging and the level of charging will impact battery life expectations. Routes used, climate, idle durations, drive styles, road condition, time of day, altitude, traffic, will all also have an impact on vehicle life expectancy. Maintenance factors such as intervals at which maintenance is performed can impact efficiency. As a fleet, the aggregate score may be a function of both the average fleet score, among the vehicles in the fleet, as well of the standard deviation of individual scores. This is because, with the goal of maximizing residual value, the fleet manager also needs to replace all, or a significant part of, the fleet at the time of the lease renewal.

On any given day, manager will have a set of tasks to support the vehicles in the fleet. These could be delivery of goods, getting a construction crew to a job site, EMS, etc. A constrained resource to maintain vehicles is needed. Not all vehicles can be inspected at the same time, so scheduling and prioritizing is necessary. In accordance with one or more embodiments, a manager assigns a set of tasks and/or maintenance to a first set of vehicles, including parking assignments for end of day. Next, a new VLES score may be determined for each vehicle in a fleet. In accordance with one or more embodiments, the new VLES score may be determined as a current score. Next, random pairs of vehicles are considered with different tasks and maintenance swapped. A manager then reevaluates an impact on an overall fleet score using alternative new VLES scores. If a score increases, the changes are kept. If not, the prior tasks may remain in place. Thus, if no increase occurs, the method concludes, otherwise, a manager repeats random pair evaluations until each unit is considered and the VLES score converges to a total average with a lowest possible deviation. Next, the manager deploys and schedules operations in accordance with the results.

As a result of the method, the overall life expectancy of the fleet is extended as a homogeneous planned vehicle obsolescence. In one or more embodiments, the VLES score is similar to a FICO score of a borrower to determine reliability of an individual's credit. In one or more embodiments, the VLES is based on known parameters, including the aggregate vehicle wear. For an electric vehicle, the battery may be the dominant factor in determining vehicle wear. In other embodiments, a lease requirement or other contractual determinatives may be a dominant factor. For example, if a maximum mileage or minimum percentage of batter life percentage is reached or expected.

In one or more embodiments, a VLES score may be affected by actions that are considered. For example, where a vehicle is parked and state of charge during storage may have an impact on wear. Specifically, if a vehicle is stored outdoors in a cold environment, significant wear may incur to the batteries. Further, the type and speed of charging electric batteries impacts battery life. For petroleum fuel based vehicles, the type and quality of fuels used impacts longevity of a vehicle.

Referring now to FIG. 1, a system in accordance with one or more embodiments illustrates a fleet of vehicles 102, which may be electric vehicles having one of the six levels of automation, or be vehicles without any level of automation. In some embodiments, fleet of vehicles 102 includes an electric battery for which fleet management benefits the obsolescence of battery life of the fleet as a whole.

Each vehicle in fleet 102 is shown coupled to cloud network 120 to provide data and receive scheduling data from a fleet management server 130. Fleet 102 includes vehicles 104, 106, 108, 110 and 112. A fleet manager 140 is illustrated with access to fleet management server 130. In accordance with embodiments, fleet manager 140 may be responsible for maximizing the overall life expectancy of fleet 102. Accordingly, methods herein address scheduling of vehicle tasks, such as routing, fueling and/or charging, and maintenance. For example, fleet manager 140 may be responsible for identifying vehicle tasks for fleet 102 as a whole, not only which routes should be taken, but which vehicle is more appropriate for being assigned a certain route such that the fleet as a whole is not negatively affected. If a particularly difficult route is more often assigned to a particular vehicle or two, the fleet as a whole will suffer because the longevity of fleet 102 is negatively affected. In such a scenario, a leased fleet may not meet criteria necessary for contractual requirements associated with the longevity and obsolescence of fleet 102.

In accordance with one or more embodiments, each vehicle in fleet 102 are purposed to perform a set of operations, which could include delivery of goods, delivery of personnel, such as transporting a construction to a job site, and the like. In one or more embodiments, each vehicle could be an ambulance or other emergency medical service vehicle. Thus, vehicles in fleet 102 may be tasked with different types of work, tasks, or operations depending on the business served. Regardless of the type of business, in accordance with embodiments, fleet 102 is subject to some constraint to maintain the vehicles. Thus, inspections, maintenance and the like is necessary across fleet 102. Not all vehicles in fleet 102 may be inspected simultaneously, so one or more embodiments are directed to scheduling and prioritizing such scheduling of maintenance tasks.

In one or more embodiments, fleet 102 may be fuel-based vehicles, internal combustion engine (ICE) type vehicles, or electrical vehicles. In one or more embodiments, each vehicle in fleet 102 are the same type of vehicle to enable consistent obsolescence over time. Each vehicle, however, may be managed independently depending on fleet management choices covering fuel choices, manner of charging for electric vehicles and the like depending on business requirements. Other managed operational factors affecting a fleet include manner of parking each vehicle, such as indoor or outdoor and the like. Fleet manager 140 may have an objective of achieving an optimal fleet vehicle life expectancy score (VLES) that balances between an overall average health of the fleet and

The balance between overall average health and spread will be established depending on the cost advantage of fleet block renewal.

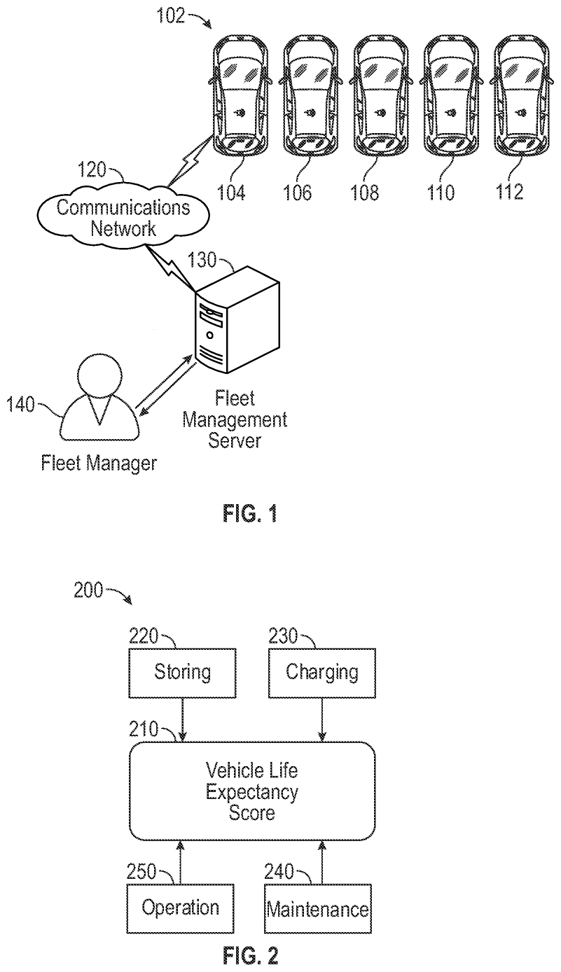

Accordingly, one or more embodiments are directed to generating a “vehicle life expectancy score” (VLES). Referring to FIG. 2, a flow diagram 200 illustrates exemplary contributory factors for generating a VLES. As shown, VLES 210 may be generated by considering data associated with storage data 220, charging data 230, maintenance data 240, and operation data 250. Such data 220, 230, 240 and 250 may also include other known parameters affecting aggregate vehicle wear. In one or more embodiments, VLES 210 may also be based on other factors, such as lease requirements as stated in a contract upon return of a vehicle. For example, some lease requirements state a maximum mileage and minimum percentage battery life expected upon completion of the lease term. Thus, VLES 210 may be impacted by a plurality of vehicle operations. For example, charging data 230 may include the speed and type of charging and the level of charging each vehicle in fleet of vehicles 102, because such charging operations impact battery life expectations.

Storage data 220 may include data concerning where fleet vehicles are parked. For electric vehicles, storage data 220 may be very important in that batteries are very susceptible to variations in temperature. For example, if an electric vehicle is kept in a cold environment or a hot environment, the battery may have a shorter useful life. Therefore, it may be beneficial to rotate which vehicles are susceptible to different elements as opposed to kept in a garage, for example.

Operation data 250 may include data associated with routes used, the climate during a route, idle durations, driving styles, road conditions, time of day, altitude, and traffic. Each operation data impacts vehicle life expectancy. For example, routes may be difficult or flat, the amount of time a vehicle is required to remain in idle may negatively affect an engine, and driving styles associated with drivers of the fleet of vehicles 102 may further affect a vehicles longevity if the driving style causes early brake wear and tear, for example. Other driving styles may be beneficial for a vehicle such as drivers that are battery conscientious. Battery conscientious drivers are known to extend battery life by driving styles that keep a vehicle at a level electrical usage with few quick accelerations or electrical drains.

Maintenance data 240 may include factors such as intervals at which maintenance is performed which impacts efficiency. For example, maintenance data may include oil change data, fluid maintenance data, tire change data, battery maintenance data, and other factors related to maintaining a vehicle, either electric or non-electric vehicle.

In one or more embodiments, VLES 210 for the fleet of vehicles 102 is an aggregate score determined as a function of both an average fleet score taken based on the vehicles in the fleet 102, as well as a standard deviation based on VLES of individual scores. In one or more embodiments, VLES 210 assists fleet manager 140 maximize residual value of fleet of vehicles 102. For example, fleet manager 140 may need to determine when to replace fleet 102 or a significant portion of fleet 102 when a fleet is under a contract for renewal or the like.

In one embodiment, the VLES for a fleet is equal to a weighted average multiplied by the sum of each vehicle's VLES score plus a weighted standard deviation of the fleet of vehicles 102. The weights w_{avg} and w_{std}

$$\\ V L E {S}_{fleet} = {w}_{avg} {\sum }_{vehicles} V L E {S}_{vehicle} + {w}_{std} \sqrt{{\sum }_{vehicles} {( V L E {S}_{vehicle} - V L E {S}_{avg} )}^{2}}$$

In one embodiments, the weights w_{avg} and w_{std} are set by fleet manager 140. For example, if there are known issues with the fleet there could be a weighting to represent underlying penalties associated with the possible need to replace some units before the rest of the fleet. For example, if a vehicle fleet has a mechanical issue that has degraded the fleet, there would be an estimate of the effect of the mechanical issue on the obsolescence of the vehicle.

In one or more embodiments, w_{std} represents a standard deviation multiple to be multiplied by a calculation of the standard deviation of the VLES. As one of skill in the art will appreciate, a standard deviation is determined by the following equation:

$$\\ {w}_{std} = x = \sqrt{\frac{\sum {( X - \overline{x} )}^{2}}{n - 1} ,}$$

where the n−1 represents the number of samples, X represents each value (such as a VLES) and x represents as sample mean value or average value for VLES. If all the vehicles are considered in determining a standard deviation, instead of n−1, the equation would use N=the total number of vehicles in the fleet.

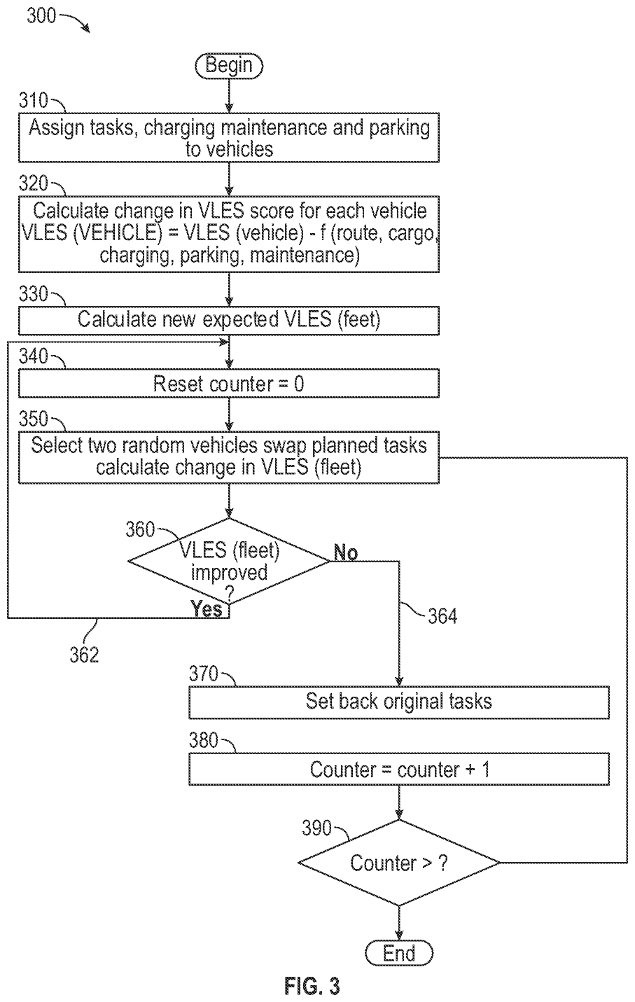

Referring now to FIG. 3 a decision flow diagram 300 illustrates how a VLES score may be used in practice. As shown, the decision blow begins at start 302. Block 310 provides for fleet manager 140 assigning tasks for each fleet vehicle such as route, cargo, charging, maintenance and parking assignments for each vehicle in the fleet 102. In one or more embodiments, the fleet manager 140 determines parking assignments.

Block 320 provides for determining a VLES score for each vehicle in the fleet 102 based on a previously determined VLES score from which an amount is subtracted as a function of the tasks to be assigned to the vehicle. For example, if fleet manager 140 determines each vehicle in a fleet 102 shall be doing a same route, a simple deduction would apply to all vehicles. Block 330 provides for calculating a new VLES score for the fleet. For example, if the same route were performed by each vehicle in fleet 102, the VLES score for the fleet would be reduced by a multiple of the number of vehicles in the fleet.

Block 340 provides for resetting a counter when tasks to be assigned to each vehicle in fleet 102 are not identical and a determination as to the correct tasks for each vehicle to maintain a consistent longevity is required in accordance with embodiments. For example, if the routes to be assigned are different, with some routes known to effect the longevity of the fleet then a decision must be made as to which vehicles may be assigned routes that degrade the fleet as a whole. In another example, some storage decisions may be not identical when garage space is limited, and it is known that a vehicle in fleet 102 must be stored in an undesirable environment affecting battery longevity.

Block 350 provides for selecting two vehicles from fleet 102, swapping the tasks to be performed by vehicles, and determining an effect on the VLES score for the fleet. In decision block 360, a question is posed as to whether the VLES score for the fleet has increased or not due to the swapping of tasks. For example, if a same vehicle 104 were assigned difficult routes and stored in a cold environment while other vehicles were stored in a garage, the longevity of vehicle 104 would be substantially different from other vehicles in fleet 102. As a result, the shortened useful life of vehicle 104 would negatively affect fleet 102 and the fleet VLES score.

Line 362 provides for determining that the swapping of the tasks benefits the fleet VLES score and returning to block 340 to reset the counter and select a different two vehicles in block 350 and so on. Line 364 provides for determining that the swapping of the tasks does not benefit the fleet VLES score and continues to block 370, which provides for setting the original tasks back to the original vehicles as assigned and block 380 provides for increasing the counter by one. Block 390 provides for asking if the counter has reached a predetermined number, such as the number of vehicles in fleet 102. In one embodiment, the counter represents the number of different unique pairs in fleet 102. As one of ordinary skill in the art will appreciate, the number of unique pairs in a set is N=(n(n−1))/2 wherein n is the total number of vehicles in fleet 102. Thus, if a fleet has 20 vehicles, N is 190. In other embodiments, the number of pairs reviewed may be fewer than 190 as a subset based on a random number generator, for example. In one embodiment, a random pair is chosen or a random number of pairs less than 190 is chosen to review, and if no increase in score for each of the random number of pairs is identified, then the process returns to block 350.

In one embodiment, the swapping of pairs for evaluation is continued until each vehicle within the fleet 102 converges to the total average VLES for the fleet with the lowest possible deviation. Thus, using the standard deviation equation above, for example, the N may be a sample size (n−1) if not all the vehicles are considered for determining a standard deviation.

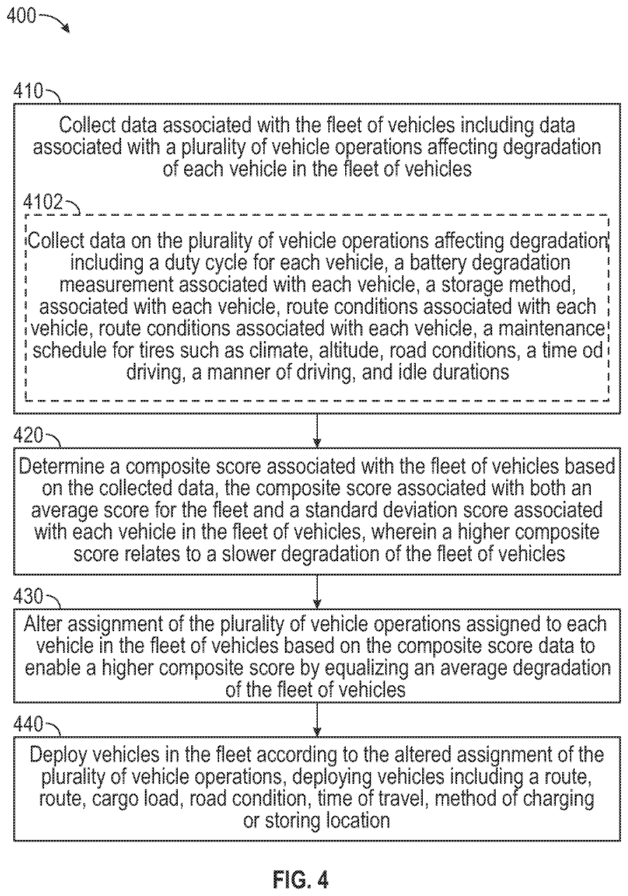

Referring now to FIG. 4 a flow diagram illustrates a method in accordance with an embodiment. As shown block 410 provides for collecting data associated with the fleet of vehicles including data associated with a plurality of vehicle operations affecting degradation of each vehicle in the fleet of vehicles. For example, fleet management server 130 coupled to fleet of vehicles 102 may collect data. As shown within block 410 is block 4102 shown in dashed lines, which provides for collecting data on the plurality of vehicle operations affecting degradation including a duty cycle for each vehicle, a battery degradation measurement associated with each vehicle, a storage method associated with each vehicle, route conditions associated with each vehicle, and a maintenance schedule for tires, fluids and brakes for each vehicle. For example, each vehicle in fleet 102 may include a transceiver and provide data to network 120 and server 130 to provide data concerning duty cycle, battery, and other vehicle related system information. Further, each vehicle, such as vehicle, 104, 106, 108 and 110 may provide GPS data to identify storage location and provide route conditions and maintenance data.

Block 420 provides for determining a composite score associated with the fleet of vehicles based on the collected data, the composite score associated with both an average score for the fleet and a standard deviation score associated with each vehicle in the fleet of vehicles, wherein a higher composite score relates to a slower degradation of the fleet of vehicles. For example, fleet management server 130 may determine the composite score after receiving the collected data.

Block 430 provides for altering assignment of the plurality of vehicle operations assigned to each vehicle in the fleet of vehicles based on the composite score data to enable a higher composite score by equalizing an average degradation of the fleet of vehicles. For example, after fleet management server 130 may determine that the plurality of vehicle operations to be performed by fleet 102 requires alteration based on the composite score.

Block 440 provides for deploying the vehicles in the fleet according to the altered assignment of the plurality of vehicle operations, the deploying the vehicles including a route, cargo load, road condition, time of travel, method of charging or storage location. For example, fleet management server 130 coupled to cloud 120 transmits deployment instructions to each vehicle 104, 106, 108, 110, and 112. Each vehicle in fleet 102 receives the deployment instructions over a wireless connection and may display route information and the like for a driver and directly into each vehicle's computer.

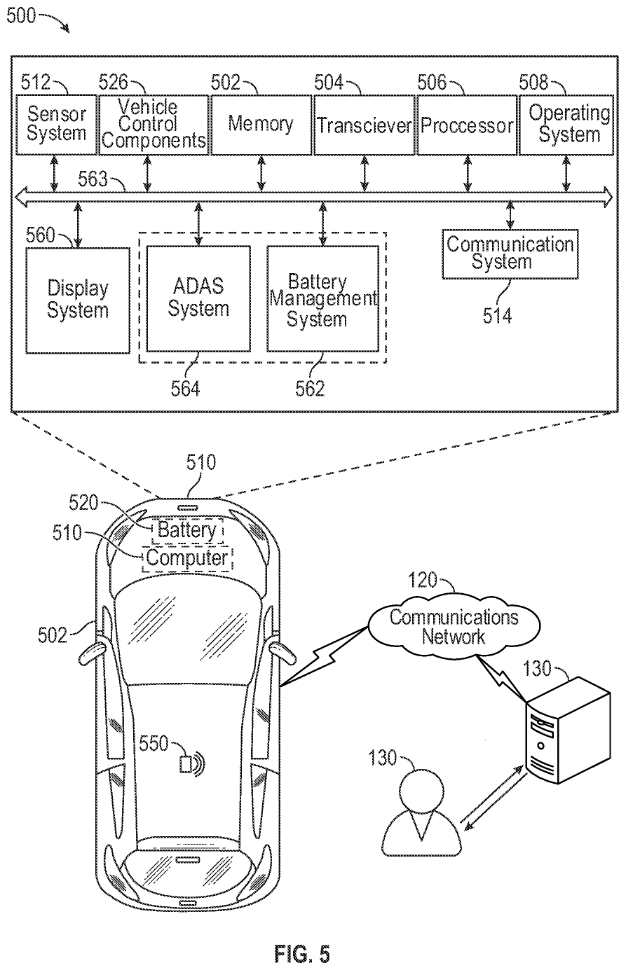

Referring now to FIG. 5, in one embodiment, the fleet of vehicles 102 includes electric vehicles. FIG. 5 illustrates electric vehicle 502, with a battery 520, and on-board computer 510. In other embodiments, vehicle 502 may be one of various types of vehicles with a chassis and may be a gasoline powered vehicle, an electric vehicle, a hybrid electric vehicle, or an autonomous vehicle, that is configured as a Level 2 or higher automated or semi-automated vehicle. In one embodiment, vehicle 502 is a fleet vehicle that can include a vehicle on-board computer 510, and a sensor system 512 coupled to display 560. On-board computer 510 includes at least a memory 522 and processor 505 coupled to the memory 502 wherein the processor 505 is configured to receive instructions over transceiver 504. On-board computer 510 is shown including operating system, sensor system 512 and vehicle control components 525, which are coupled to bus 563.

The vehicle on-board computer 510 may perform various functions via vehicle control components 525 such as controlling engine operations (fuel injection, speed control, emissions control, braking, etc.), managing climate controls (air conditioning, heating etc.), activating airbags, and issuing alerts (check engine light, bulb out, low tire pressure, vehicle in a blind spot, etc.).

The vehicle computer on-board computer 510, in one or more embodiments, may be used to support features such as remotely-controlled vehicle maneuvering operations, and remote vehicle monitoring operations. Further, in accordance with embodiments, on-board computer 510 may receive instructions over communications network 120 from server 130 implementing methods in accordance with embodiments. For example, battery management system may receive fleet management instructions from a fleet manager 130.

In one or more embodiments, vehicle 502 receives an assignment related to a plurality of vehicle operations based on a composite score associated with the fleet of vehicles 102, the composite score (VLES) associated with both an average score for the fleet and a standard deviation score associated with each vehicle in the fleet of vehicles, wherein a higher composite score relates to a slower degradation of the fleet of vehicles, the assignment enabling a higher composite score by equalizing an average degradation of the fleet of vehicles 102.

In one or more embodiments, vehicle 502 provides data associated with a plurality of vehicle operations over communication system 514 including a duty cycle, a battery degradation measurement from battery management system 562, a storage method, route conditions such as from a GPS, and a maintenance schedule for tires, fluids and brakes for vehicle 502.

In one or more embodiments, the assignment received by vehicle 502 includes a route, a cargo load, a road condition, a time of travel, a method of charging, or a storage location. The route condition may include a time of driving, a manner of driving, and an idle duration.

The vehicle on-board computer 510 may perform various functions such as controlling engine operations (fuel injection, speed control, emissions control, braking, etc.), managing climate controls (air conditioning, heating etc.), activating airbags, and issuing alerts (check engine light, bulb out, low tire pressure, vehicle in a blind spot, etc.). In one or more embodiments, vehicle on-board computer 510 may enable a self-driving car or provide driver assistance, such as to a driver for fleet of vehicles 102. Thus, vehicle on-board computer 110 may further include an Advanced Driver-Assistance System (“ADAS”) system 564.

In one or more embodiments, vehicle 502 includes communications system 514 implemented as a cellular or Wi-Fi communication link enabling vehicle 502 to communicate with network 120, which may include a cloud-based network or source for transferring data to and from fleet management server 130 in accordance with this disclosure.

Vehicle 502 may further include a set of nodes, sensors 550 such as radars and cameras mounted upon vehicle 502 in a manner that allows the vehicle on-board computer 510 to communicate with devices and sensor system 512 and collect and transmit and receive data. Examples of may include sensors, radars and/or emitters capable of detecting objects, distances such as ultrasonic radar, LiDAR, cameras and the like. In one or more embodiments, sensors/cameras may further include one or more of Bluetooth®-enabled sensors, or Bluetooth® low energy (BLE)-enabled sensors, wheel speed sensors, accelerometers, rate sensors, GPS sensors, and steering wheel sensors. In one or more embodiments, the sensors may include driver state monitoring cameras (DSMC), interior, passenger and occupant cameras, LiDAR sensors, RADAR sensors, ultrasonic sensors, and Ultra-Wideband (UWB) sensors.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” “example implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, mobile devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments, as will be understood by those of ordinary skill in the art with the benefit of the present disclosure.

That which is claimed is:

1. A method for fleet management for a fleet of vehicles, comprising:
collecting data associated with the fleet of vehicles including data associated with a plurality of vehicle operations affecting degradation of each vehicle in the fleet of vehicles;
determining a composite score associated with the fleet of vehicles based on the collected data, the composite score associated with both an average score for the fleet of vehicles and a standard deviation score associated with each vehicle in the fleet of vehicles, wherein a higher composite score relates to a slower degradation of the fleet of vehicles; and
altering assignment of the plurality of vehicle operations assigned to each vehicle in the fleet of vehicles based on the composite score to enable the higher composite score by equalizing an average degradation of the fleet of vehicles.

2. The method of claim 1, wherein collecting data associated with the fleet of vehicles including data associated with the plurality of vehicle operations affecting degradation of each vehicle in the fleet of vehicles comprises:
collecting data on the plurality of vehicle operations affecting degradation including:
a duty cycle for each vehicle;
a battery degradation measurement associated with each vehicle;
a storage method associated with each vehicle;
route conditions associated with each vehicle; and
a maintenance schedule for tires, fluids and brakes for each vehicle.

3. The method of claim 2, wherein the route conditions associated with each vehicle comprises:
a climate, an altitude, road conditions, a time of driving, a manner of driving, and idle durations.

4. The method of claim 1, wherein the determining the composite score associated with the fleet of vehicles based on the collected data, further comprises:
assigning the vehicle operations to the fleet of vehicles;
assigning a vehicle score for each vehicle in the fleet of vehicles, each vehicle starting with a same new vehicle score based on expected longevity;
determining a revised vehicle score based on expected wear for each vehicle operation;
swapping vehicle operations assigned to random pairs of vehicles in the fleet of vehicles to evaluate an impact on the composite score of the fleet of vehicles;
if the swapping of vehicle operations to random pairs of vehicles increases the composite score of the fleet of vehicles, maintaining the swapping of vehicle operations;
if the swapping of vehicle operations decreases the composite score of the fleet of vehicles, reverting the swapping of vehicle operations; and
repeating the swapping of vehicle operations until a convergence to a lowest possible standard deviation affecting the composite score of the fleet of vehicles.

5. The method of claim 4, wherein the swapping of vehicle operations assigned to random pairs of vehicles in the fleet of vehicles to evaluate an impact on the composite score of the fleet of vehicles further comprises:
swapping random pairs of vehicles in the fleet of vehicles until N pairs are considered wherein N=(n(n−1))/2 wherein n is a total number of vehicles in fleet.

6. The method of claim 1, wherein altering assignment of the plurality of vehicle operations assigned to each vehicle in the fleet of vehicles based on the composite score to enable the higher composite score by equalizing the average degradation of the fleet of vehicles, further comprises:
determining the composite score based on a vehicle life expectancy score (VLES) as a weighted score assigned to each vehicle and an average VLES for the fleet of vehicles,
wherein
$$\\ V L E {S}_{fleet} = {w}_{avg} {\sum }_{vehicles} V L E {S}_{vehicle} + {w}_{std} \sqrt{{\sum }_{vehicles} {( V L E {S}_{vehicle} - V L E {S}_{avg} )}^{2}} ,$$
wherein w_{avg} and w_{std} are weights set as a function of a plurality of negative factors associated with the fleet of vehicles affecting obsolescence of the fleet of vehicles.

7. The method of claim 6, wherein altering assignment of the plurality of vehicle operations assigned to each vehicle in the fleet of vehicles based on the composite score to enable the higher composite score by equalizing the average degradation of the fleet of vehicles, further comprises:
determining the weights w_{avg} and w_{std} based on known degradation parameters.

8. The method of claim 1, further comprising:
deploying vehicles in the fleet of vehicles according to the altered assignment of the plurality of vehicle operations, the deploying vehicles including a route, cargo load, road condition, time of travel, method of charging, or storage location.

9. A system, comprising:
a memory that stores computer-executable instructions;
a transceiver coupled to memory, the transceiver configured to receive data related to a fleet of vehicles;
a processor configured to access the memory and execute the computer-executable instructions to:
collect data received from the transceiver associated with the fleet of vehicles including data associated with a plurality of vehicle operations affecting degradation of each vehicle in the fleet of vehicles;
determine a composite score associated with the fleet of vehicles based on the collected data, the composite score associated with both an average score for the fleet of vehicles and a standard deviation score associated with each vehicle in the fleet of vehicles, wherein a higher composite score relates to a slower degradation of the fleet of vehicles; and
alter assignment of the plurality of vehicle operations assigned to each vehicle in the fleet of vehicles based on the composite score to enable a higher composite score by equalizing an average degradation of the fleet of vehicles.

10. The system of claim 9, wherein the processor configured to execute the computer-executable instructions to collect data from the transceiver associated with the fleet of vehicles including data associated with the plurality of vehicle operations affecting degradation of each vehicle in the fleet of vehicles is further configured to:
collect data from the transceiver on the plurality of vehicle operations affecting degradation including:
a duty cycle for each vehicle;
a battery degradation measurement associated with each vehicle;
a storage method associated with each vehicle;
route conditions associated with each vehicle; and
a maintenance schedule for tires, fluids and brakes for each vehicle.

11. The system of claim 10, wherein the route conditions associated with each vehicle comprises:
a climate, an altitude, road conditions, a time of driving, a manner of driving, and idle durations.

12. The system of claim 9, wherein the processor configured to execute the computer-executable instructions to determine the composite score associated with the fleet of vehicles based on the collected data is further configured to:
assign vehicle operations to the fleet of vehicles;
assign a vehicle score for each vehicle in the fleet of vehicles, each vehicle starting with a same new vehicle score based on expected longevity;
determine a revised vehicle score based on expected wear for each vehicle operation;
swap vehicle operations assigned to random pairs of vehicles in the fleet of vehicles to evaluate an impact on the composite score of the fleet of vehicles;
if the swap of vehicle operations to random pairs of vehicles increases the composite score of the fleet of vehicles, maintain the swap of vehicle operations;
if the swap of vehicle operations decreases the composite score of the fleet of vehicles, revert the swap of vehicle operations; and
repeat the swap of vehicle operations until a convergence to a lowest possible standard deviation affecting the composite score of the fleet of vehicles.

13. The system of claim 12, wherein the processor configured to execute the computer-executable instructions to swap vehicle operations assigned to random pairs of vehicles in the fleet of vehicles to evaluate an impact on the composite score of the fleet of vehicles is further configured to execute computer-executable instructions to:
swap random pairs of vehicles in the fleet of vehicles until N pairs are considered wherein N=(n(n−1))/2 wherein n is a total number of vehicles in fleet.

14. The system of claim 9, wherein the processor is configured to execute instructions to alter assignment of the plurality of vehicle operations assigned to each vehicle in the fleet of vehicles based on the composite score to enable the higher composite score by equalizing the average degradation of the fleet of vehicles, is further configured to execute instructions to:
determine the composite score based on a vehicle life expectancy score (VLES) as a weighted score assigned to each vehicle and an average VLES for the fleet of vehicles,
wherein:
$$\\ V L E {S}_{fleet} = {w}_{avg} {\sum }_{vehicles} V L E {S}_{vehicle} + {w}_{std} \sqrt{{\sum }_{vehicles} {( V L E {S}_{vehicle} - V L E {S}_{avg} )}^{2}} ,$$
and
wherein w_{avg} and w_{std} are weights set as a function of a plurality of negative factors associated with the fleet of vehicles affecting obsolescence of the fleet of vehicles.

15. The system of claim 14, wherein the processor configured to execute the computer-executable instructions to alter assignment of the plurality of vehicle operations assigned to each vehicle in the fleet of vehicles based on the composite score to enable the higher composite score by equalizing the average degradation of the fleet of vehicles is further configured to execute the computer-executable instructions to:
determine the weights w_{avg} and w_{std} based on known degradation parameters.

16. The system of claim 14, wherein the processor configured to execute the computer-executable instructions to alter assignment of the plurality of vehicle operations assigned to each vehicle in the fleet of vehicles based on the composite score to enable the higher composite score by equalizing the average degradation of the fleet of vehicles is further configured to execute the computer-executable instructions to:
deploy vehicles in the fleet of vehicles according to the altered assignment of the plurality of vehicle operations, the deploying vehicles including a route, cargo load, road condition, time of travel, method of charging or storage location.

17. An electric vehicle in a fleet of vehicles, comprising:
a plurality of batteries; and
a vehicle computer coupled to the battery, the vehicle computer configured with:
a memory that stores computer-executable instructions;
a transceiver coupled to memory, the transceiver configured to receive data associated with the fleet of vehicles including data associated with a plurality of vehicle operations affecting degradation of each vehicle in the fleet of vehicles; and
a processor configured to access the memory and execute the computer-executable instructions to:
receive an assignment related to the plurality of vehicle operations based on a composite score associated with the fleet of vehicles, the composite score associated with both an average score for the fleet of vehicles and a standard deviation score associated with each vehicle in the fleet of vehicles, wherein a higher composite score relates to a slower degradation of the fleet of vehicles, the assignment enabling a higher composite score by equalizing an average degradation of the fleet of vehicles.

18. The electric vehicle of claim 17, wherein the data associated with a plurality of vehicle operations includes a duty cycle, a battery degradation measurement, a storage method, route conditions, and a maintenance schedule for tires, fluids and brakes for each vehicle.

19. The electric vehicle of claim 17, wherein the assignment is one of a plurality vehicle operations including a route, a cargo load, a road condition, a time of travel, a method of charging or a storage location.

20. The electric vehicle of claim 18, wherein the route conditions includes a time of driving, a manner of driving, and an idle duration.
